(19) United States
(12) Patent Application Publication
(10) Pub. No.: US 2025/0298769 A1
(43) Pub. Date: Sep. 25, 2025

(54) COMPUTING SYSTEM VARIABLE LENGTH BUS

(71) Applicant: ICAT, LLC d/b/a Turing Micro, Terre Haute, IN (US)

(72) Inventor: George Jeffrey Bennett, Murrieta, CA (US)

(73) Assignee: ICAT, LLC d/b/a Turing Micro, Terre Haute, IN (US)

(21) Appl. No.: 19/085,809

(22) Filed: Mar. 20, 2025

Related U.S. Application Data
(60) Provisional application No. 63/567,820, filed on Mar. 20, 2024.

(51) Int. Cl. G06F 13/42; G06F 13/40

(52) U.S. Cl. CPC G06F 13/4282; G06F 13/4072

(57) ABSTRACT

A variable length bus that is flexible to increase the number of short hanl transfers without severely impeding the total bus capability, thus increasing total bus throughput and decreasing average latency. The variable length bus also makes the distribution of the bus manageable using very simple RAPC cores, minimizing control overhead.

### BACKGROUND

In computing architecture, a bus (also known as a “data bus”) is a communication system that transfers data between components.

We are concerned here with multi-core CPU arrays that have data buses.

A bus is distinguished from ‘just a bunch of wires’ by the protocol defined that allows components (bus ‘clients’) to send data on the bus, read data from the bus, and coherently organize data transfer, typically to and from more than one bus client. Buses can use serial or parallel communications. Tristate buses are designed to allow traffic to or from a client on the same set of wires using a high impedance state for the drivers to save wires. Buses built with integrated circuitry may not have tristate options, which may force the use of non-tristated drivers where separate lines travel between clients in only one direction.

We consider here a bus that connects multiple clients (CPUs, I/O or memory) in a regularly spaced XY layout on a common substrate, needing a common communications network.

The term ‘bus length’ needs clarification. Usually as the number of clients increases, there is a corresponding increase in the physical length of the connections. However, the client count more drastically increases bus demands than physical length. We refer here to the term ‘bus length’ to also infer an increase in bus client count as the driving factor in the problem.

The problem with a conventional fixed length data bus is limited data transfer capacity. Several factors contribute to this issue. First, any data bus has more traffic as the number of bus clients goes up, Since the bus bandwidth is unchanged or even degrades with increased client count and physical length, the bus represents a real limit to throughput that gets much worse as total bus client count or physical bus length increases.

Second, the generally inflexible nature of most high speed buses requires address and payload data to simultaneously be transmitted. The transfers get longer (especially if the bus is serial) or require wider data paths for parallel buses. Wider paths require more careful layout and synchronization, which exact performance penalties.

Third, cach transfer occupies the whole bus regardless of the required travel distance. A data bus has a fixed throughput limit somewhat independent of distance between clients. This data bottleneck results in large inefficiency and a waste of resources that especially penalizes longer transfers and longer buses with more clients as traffic increases on the bus. The larger the client count, the more bus performance restricts the performance of the computing fabric. As algorithms become more complex and use more distant cores and the number of cores grows, bus traffic rapidly comes to dominate performance.

Fourth, in addition to the bus itself, the area directly around the bus client entry/exit points also gets congested.

Fifth, most bus protocols place strict organizational requirements on the source and destination of each data transfer, necessitating coordinating protocols. This coordinating activity usually requires a significant negotiation phase between the source and destination before data can be transferred, further degrading bus performance and arguing for lengthy bus messages to minimize the impact of negotiations on total bus throughput. Coordinating activity timing is bus overhead that adds to the total latency, or delay, that bus usage adds to the total computation time. This activity also requires coherency between the source and destination, which can be difficult if the two are widely separated or if there are many clients.

There is a need to make the bus length dynamically flexible to increase the total bus throughput and decrease average latency as client count increases.

There is also a need to make the distributed bus protocol manageable using very simple clients, minimizing control overhead.

### SUMMARY

Embodiments of the present invention provide a variable length two dimensional bus that addresses the issues described above by splitting the bus dynamically into multiple smaller bus segments and providing custom multiple paths at each data transfer to raise bus throughput while keeping distributed client based bus management simple. Various embodiments of such a variable length bus are described herein.

Embodiments of the present invention may have various features and provide various advantages. Any of the features and advantages of the present invention may be desired, but, are not necessarily required to practice the present invention.

### BRIEF DESCRIPTION OF THE DRAWINGS

FIG. 1 is a diagram of data transfer interconnections for a Reprogrammable Arithmetic Pipelined Core (“RAPCO”) arranged in an XY physical layout according to an embodiment.

FIG. 2 is a diagram of a typical data flow that does not use a data bus in a RAPC fabric, according to an embodiment.

FIG. 3 is a diagram of bus interconnections for an array of 9 RAPCs, according to an embodiment.

FIG. 4 is a block diagram of basic bus and switch signals and controls, according to an embodiment.

FIG. 5 is a diagram of a bus limited 4 Tile RAPC array, according to an embodiment.

FIG. 6 is a diagram of various desirable data paths including shorthaul (top) and longer vertical paths (bottom), according to an embodiment.

FIG. 7 is a diagram of a 4 way switch driving tristate buses where a meta tag also accompanies the data in an identical parallel switch, according to an embodiment.

FIG. 8 is a diagram of a routing for the bus feedback signal Uhalt\ where only 1 set of 4 gates is needed, according to an embodiment.

FIG. 9 is a diagram of a non-tristate version of the switch, according to an embodiment.

FIG. 10 is a diagram of isolating the local bus traffic from medium and long haul bus traffic, according to an embodiment.

FIG. 11 is a diagram of a multi-path performance enhancement, according to an embodiment.

FIG. 12 is a diagram of a 4 layer priority arbitration structure that sets the switch controls according to requested paths using common prioritized numbers, according to an embodiment.

### INTRODUCTION

### Example Embodiment: a Multiple CPU Array

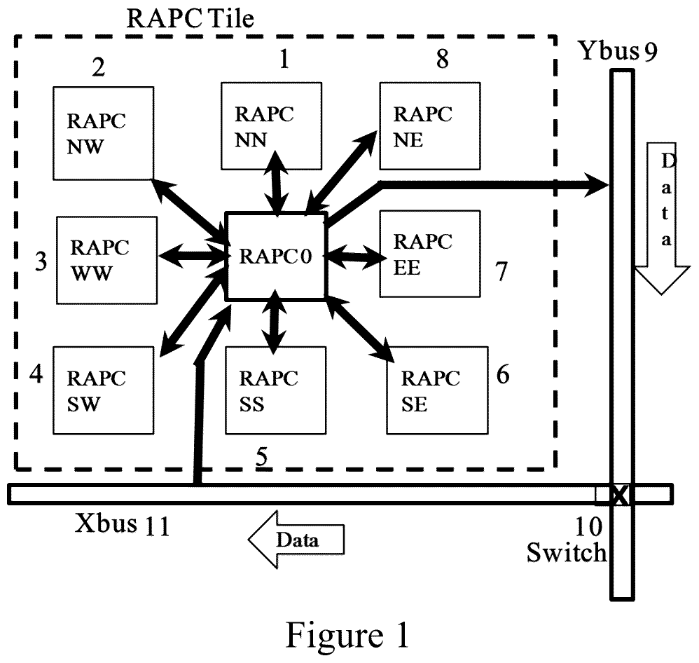

Our example embodiment is illustrated with a multiple CPU architecture that uses a dense XY layout of very simple distributed CPU cores shown in FIG. 1. The XY array of these cores is called here the “fabric.” We are concerned with the communication between these cores which are bus clients. Peripheral circuits and memories that use the same bus protocol are treated as additional clients.

In this architecture, each CPU, called a Reprogrammable Arithmetic Pipelined Core (“RAPC”), consists of a greatly simplified CPU with a specialized, extensive communication network between adjacent CPUs. FIG. 1 shows the interconnects for RAPC0 (center). A RAPC is much simpler than a standard CPU. The computing power of the fabric depends on using a large number of very small computing units.

A distinct difference between the dataflow architecture of this example and traditional CPU architectures is that the dataflow architecture keeps data moving through the cores sequentially on a single transfer clock (Xclk) cycle, rather than doing extensive computations within single cores. This approach has unique flexibility in organization and throughput but puts added demands on the data buses.

The reader will note the absence of clock signals in the discussion; all interactions must complete within a single Xclk cycle. The transfer clock signals the output latches of the RAPC that the last computational cycle is complete, and that the next cycle has now begun. Each RAPC receives data from any adjacent RAPC, processes the data within a single transfer clock cycle, then passes the data on to any adjacent RAPC (1 through 8) for the next operation. Adjacent data passing is the primary means of communication within the fabric.

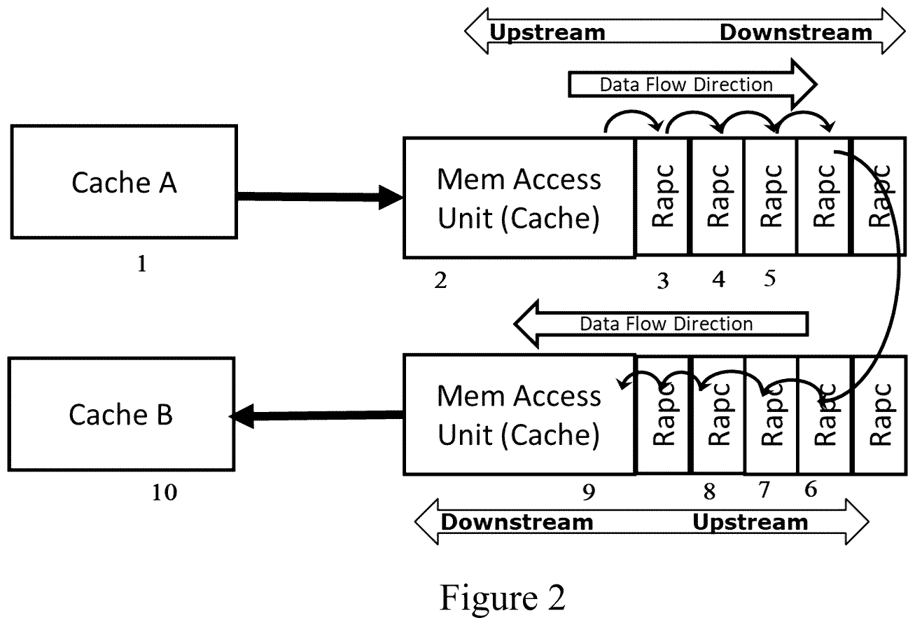

A simplified example of how operations within the RAPC fabric can be arranged is shown conceptually in FIG. 2. In this first example the bus structure is not used; data travels entirely between adjacent RAPCs. Data is operated on in assembly line fashion.

Memory Cache A 1 supplies data requested by Memory Access Unit 2, which feeds the data into the first RAPC 3. In turn, data is processed by RAPCs 4, 5, 6, 7 and 8, and arrives at a second Memory Access Unit 9, which returns the data to a second Cache arca B 10. This arrangement is capable of processing data at very high throughput; data can be processed at 1 clock cycle per data regardless of the length of the RAPC chain. Algorithms such as tapped delay line filters are thus casy to directly lay out within this fabric.

In an analogy to water flowing in a stream, data travel on a predetermined or programmed path is said to flow on that path. The originator of the data (the data source) is called the upstream client. The receiver of the data (the data sink) is called the downstream client. More than one client can be downstream from the originator; more than one client can be an upstream source of data, as RAPCs frequently need multiple arguments for their computations.

Data paths usually have extensive branches. Arrangements for a data bus that can reach any RAPC on the die while minimizing performance losses are what this invention addresses. Further, I/O and memory operations are usually done on the fabric edges. However, the number of CPU cores on the edge of the array grows only as the square root of the number of cores in the fabric. Also, the number of cores adjacent to each core in the fabric is constant, while the total number of cores grows with fabric size. Hence the importance of non-adjacent data bus communications dramatically increases with fabric size and with algorithm complexity.

These problems are only somewhat relieved by the fact that in any distributed computing structure the number of transactions typically falls off with distance between clients. Unfortunately, in an XY matrix the number of clients will tend to grow as the square of the distance; in many applications, this number can go up as the 4^{th} power of the distance.

### Routing Needs to be as Modifiable as Possible

Any current computing software is easily modified as algorithms are improved or debugged. There is a need to make the RAPC fabric and bus structure as easily programmable as software. It should be generally unnecessary to redesign the hardware to modify behavior or install a new algorithm.

Because the number of transfers on the bus falls off as the distance between source and data sink increases, there is also a need to make the Bus length more flexible to increase the much larger number of short haul transfers without severely impeding the total bus capability, thus increasing total bus throughput and decreasing average latency.

There is also a need to make the distribution of the bus manageable by very simple RAPC cores, minimizing control overhead.

In this example embodiment a main function of the bus structure is to ease routing through the device wherever the preferred method of adjacent communication is not feasible. Hence we concentrate our concerns on communication between non-adjacent RAPCs on a device with larger core counts.

### DETAILED DESCRIPTION OF THE INVENTION

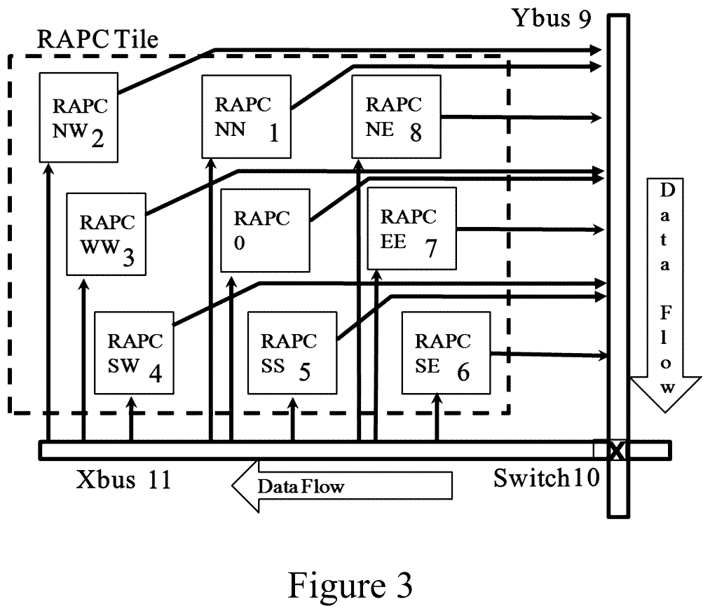

We now discuss communications that require use of the data buses. In FIG. 3, cach RAPC can write data to the YBus 9, and read data from the XBus 11. The two bus types connect through a switch 10. A number of RAPCs tic their outputs to the YBus and their inputs to the XBus. A group of RAPCs tied to a common YBus and XBus is referred to as a Tile. RAPCs on the edges of the tile can still communicate with adjacent RAPCs in different Tiles even though they use different buses.

### The YBus and XBus Organize RAPC Outputs and Inputs

By separating bus outputs from bus inputs, the RAPC and bus hardware designs become much simpler. Referring again to FIG. 3, when data must be passed to non-adjacent RAPCs, any of the RAPCs in a tile can put data on the Ybus 9, where it is transferred to the Xbus 11 via a switch 10, and is readable by all the other RAPCs on the Xbus in the tile. Tiles can be of any size, generally limited by fanout considerations and bus data capacity, and do not have to be square. Note that the XBus and YBus can only transfer one data per transfer clock cycle. It can be seen from FIG. 3 that several RAPCs can attempt to deliver data to the bus simultaneously. If more than one RAPC attempts to do so on the same clock cycle, transfer is arbitrated by a priority mechanism. Each RAPC must hold its data until the bus is clear before transferring the data. These data holds make the bus a data traffic bottleneck, a well known problem. For this reason, RAPC and I/O counts in tiles are kept small, with size determined by the type of algorithm expected to be used and the bus performance expected.

### Basic Bus Operation

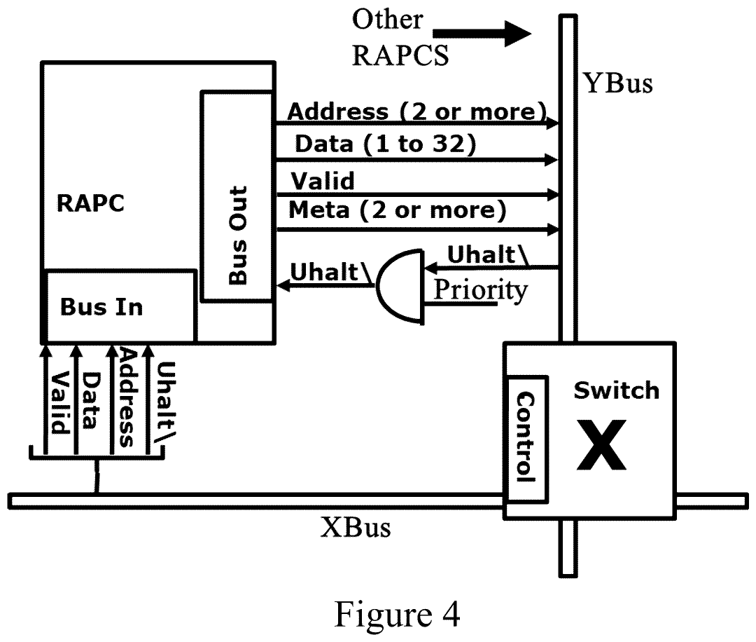

FIG. 4 shows the basic bus signals. For ease of discussion we assume specific signal polarities; polarities may differ in other implementations of the invention without loss of generality.

### Bus Output

The discussion begins with Uhalt\ (or upstream halt). When a downstream RAPC lowers Uhalt\, the RAPC pauses, holding its output register valid, while all bus drivers are tristated (if the bus is a tristatable bus). If Uhalt\ is raised, the priority circuitry enables the RAPC. If it has data to send, it places its output register contents on the YBus.

The Valid line is raised to indicate data, address and meta lines are valid. If new output from the RAPC is completed, the New line (indicating a fresh data word) is set to high. These signals are also enabled and put onto the bus. If Uhalt\ stays high through the next transfer clock edge, the data is considered transferred. The RAPC then continues to process more input data. The priority signal ensures that only one client is actively driving the bus at any given time. Many priority schemes are possible, from static priority arrangements to round robin to dynamically assigned priorities.

### Bus In

If the XBus contains a high Valid line, Uhalt\ is high and the address is correct on the valid transfer clock edge, the address and data lines are sampled by the addressed RAPC.

The switch connects various YBuses to the XBus to allow client outputs to be connected to client inputs.

### Subdivide and Conquer the Data Rate

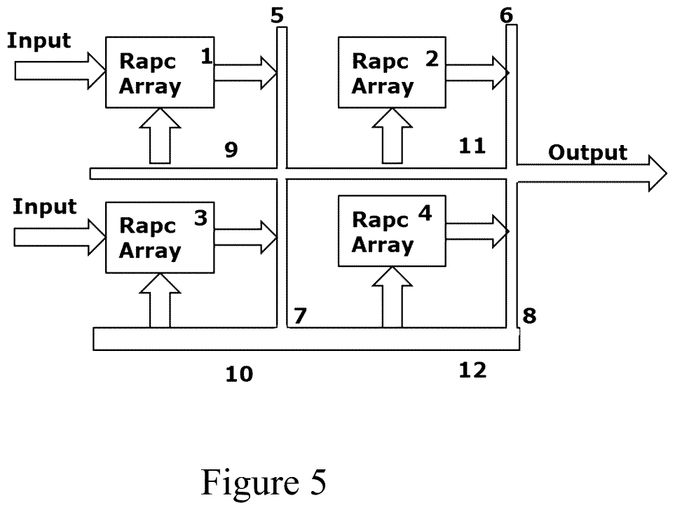

Consider FIG. 5, a 4 Tile array with several RAPCs in each tile. The YBus and XBus are all connected together without a switch, so the entire bus structure can only handle one transaction per clock. Each of the 4 RAPC tiles cannot use the bus while any of the other Tiles are transferring data. Why is it that transfers to bus 5, then to bus 9, should prevent bus 6 from transferring to bus 11? This arrangement is truly a bottleneck to the RAPC tiles.

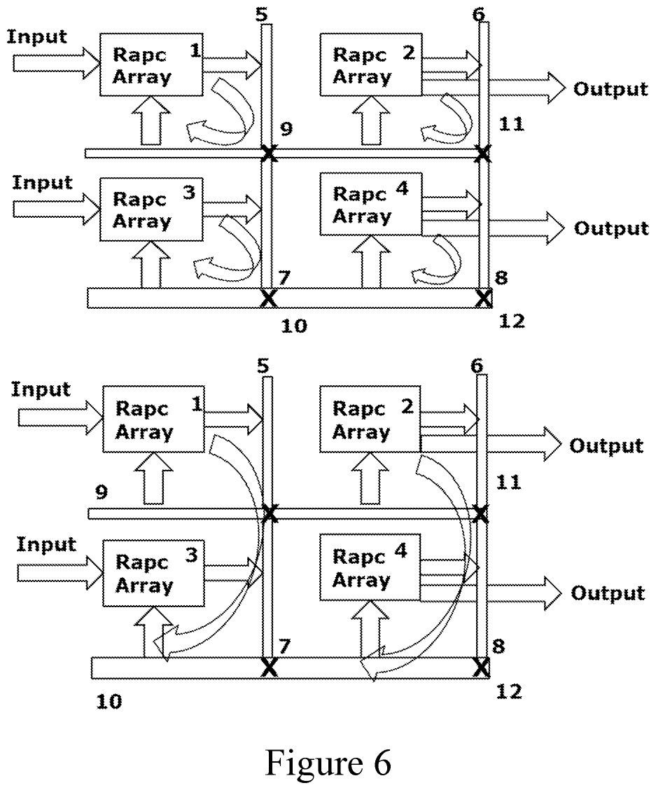

We consider placing hypothetical 4-way switches in the locations marked X 7,8,9, 11 in FIG. 6 (top) to divide up the bus into 4 smaller local buses for local traffic. Each YBus/XBus pair now handles ¼ of the traffic, so the total local RAPC bus bandwidth is effectively quadrupled. But doing so loses the long-haul capability of the bus. Looking at FIG. 6 bottom, we see another path with a medium reach that would be useful for some algorithms. Bus bandwidth is still doubled from the restrictive FIG. 5, and any algorithm arranged in this arrangement ‘vertically’ will have longer reach; data from array 1 can now also reach array 3, and data from array 2 can reach array 4 and vice versa. The output has been relegated to the RAPCs' standard output registers, which are not bused—yet arrays 1 and 3 are now isolated from the outputs, which are driven from arrays 2 and 4. There is still a division between the input processing RAPCs and the output processing RAPCs.

### The 4 Way Switch for X and Y Routing

What is needed is a 4-way switch that can separate the X and Y bus into smaller units for short transfers but reconnect as needed for longer transfers (which are often much less prevalent). By using a number of 4 way dynamic switches, the bus can be subdivided for short distances, then reconfigured when medium or long haul connections are needed. We now describe the flexible bus switch system that addresses these problems. Flexibility of data flow through the fabric is maximized with this design.

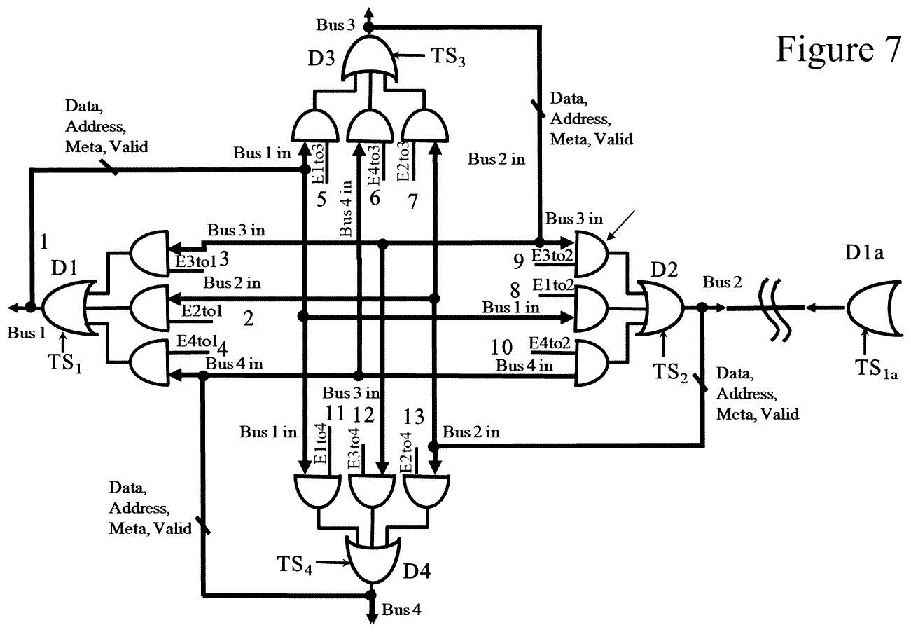

We first discuss the tristate version of the bus. Referring to FIG. 7, a set of 4 buses intersect at the 4-way switch (Bus 1 through Bus 4). These buses can be any width; all that is needed is one and-or gate with tristatable driver per data line, two control lines (Valid and Uhalt\), and a small set of lines that carry a switch meta tag with every set of bus data. The switch meta tag directs the switches to take the data from the source to the destination over a preset path. There will be at least 1 data line for a serial bus; there can be 32 or more data lines if the bus is a parallel bus design.

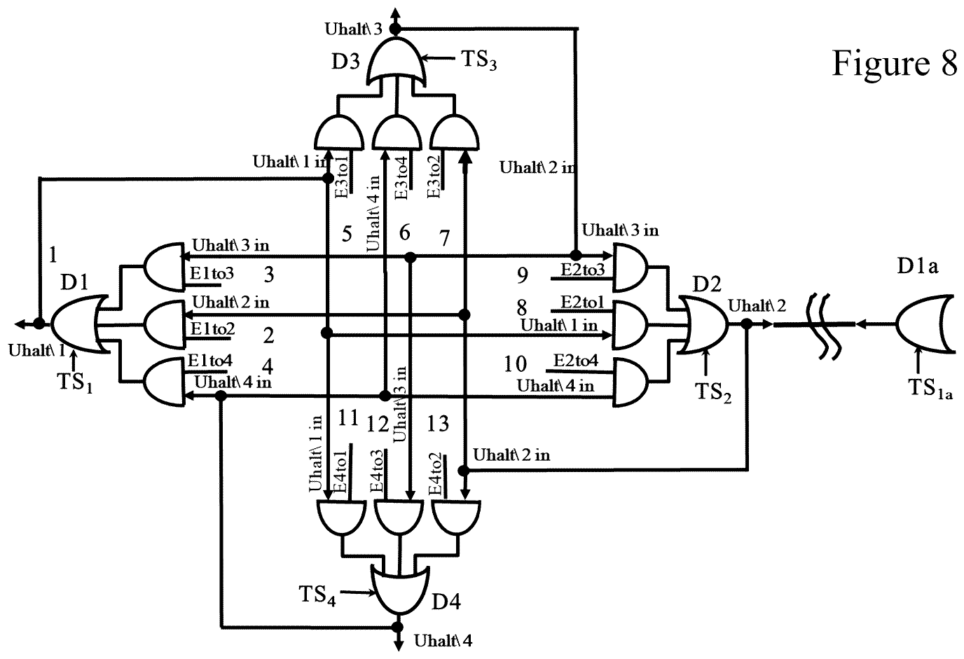

The portion of the switch that routes the Uhalt\ control line is shown in FIG. 8. It merely reverses the direction of the Uhalt\ signal to go from the downstream clients to the upstream clients, while the switch control lines 2 through 14 remain the same.

In FIG. 7 we see how these lines guide the data through the switch. Tristate drivers D1 through D4 send data onto bus 1 through bus 4. Asserting tristate control lines TS1 through TS4 turns off drivers D1 through D4 as needed to allow each bus to receive data from drivers at the other end of the bus (driver D1a is shown as an example.) TS1a is coordinated with TS2 such that both never drive Bus 2 together.

### Basic Operation

By controlling the TS signals to drive the outputs, and the various control lines to enable the bus signal from one of the other buses, each bus signal can be transferred to or from any other bidirectional bus in either direction. For example, assume that TS2 is asserted and TS1a is de-asserted, so D1a is driving bus 2. If TS1 is deasserted and control line E2to1 2 is asserted, bus 2 drives D1, putting the signal from Bus 2 out onto Bus 1. If control signal E2to1 2 is deasserted, Bus 1 is now isolated from Bus 2 regardless of the state of D2.

### Crossing Signals. Straight through Buses

We carlier used the term YBus to denote Bus 3 and 4, and Xbus to denote Bus 1 and 2. In this design the Ybus and Xbus can run totally independently of each other. Suppose we want to drive the Ybus (Bus 4) from bus 3. TS3 is asserted, while the driver at the other end of Bus 3 (not shown) supplies the bus signals. Enable signal E3to4 12 is asserted and TS4 is deasserted, so Bus 4 is driven by Bus 3. The Ybus can drive in either direction as just described using the control lines, without interfering at all with Xbus operation. The same is true of the Xbus, which is independent of the Ybus. Thus the Ybus and Xbus signals can cross each other without interfering.

### Turning Corners

We consider now how to achieve the dataflow configuration shown in FIG. 6 top. Assume the Ybus data in FIG. 7 is travelling on Bus 3 (TS3 is asserted). Control signal E3to1 3 is asserted, and TS1 is deasserted. D1 now drives Bus 1 from Bus 3, which is our corner configuration.

Again, note the isolation. Bus 2 and Bus 4 can be activated in either direction while Bus 1 and 3 are active, allowing opposing corners to be activated simultaneously.

Because of the symmetrical arrangement, any two buses can be run at the same time as any other 2 buses without signal interference as long as they are both corners or both straight through buses.

### Broadcasting

With this switch arrangement it is also possible to drive any 3 buses with the fourth bus, allowing signals to be broadcast across several buses. Assume that in FIG. 7 Bus 2 is being driven by D1a while TS2 is asserted, control signals 13, 2 and 7 can be asserted simultaneously. This puts Bus 2's signal out on all 3 of the other buses, resulting in a multi-path transmission. This is called ‘broadcasting’. The significance of this will be shown later with larger arrays.

We now see that the switch can drive from any two different input sources onto any 2 different destinations, or from any single source onto multiple destinations without conflicts.

### RAPC Feedback Control

The architecture requires control signals to prevent data collisions. All RAPCs assert the New signal and the Valid signal when they expect to write data to the bus. The New signal goes away after a single transfer clock cycle; the Valid signal indicates the data is maintained valid regardless of the clock (perhaps left over from a previous calculation or from an output that runs at a different data rate). Only the Valid signal is needed on the bus. The upstream RAPC will hold the data as long as the downstream RAPC asserts Uhalt\. No additional control signals are needed for this feedback to make its way back to the driver.

### If Tristate Circuits Are Not Feasible

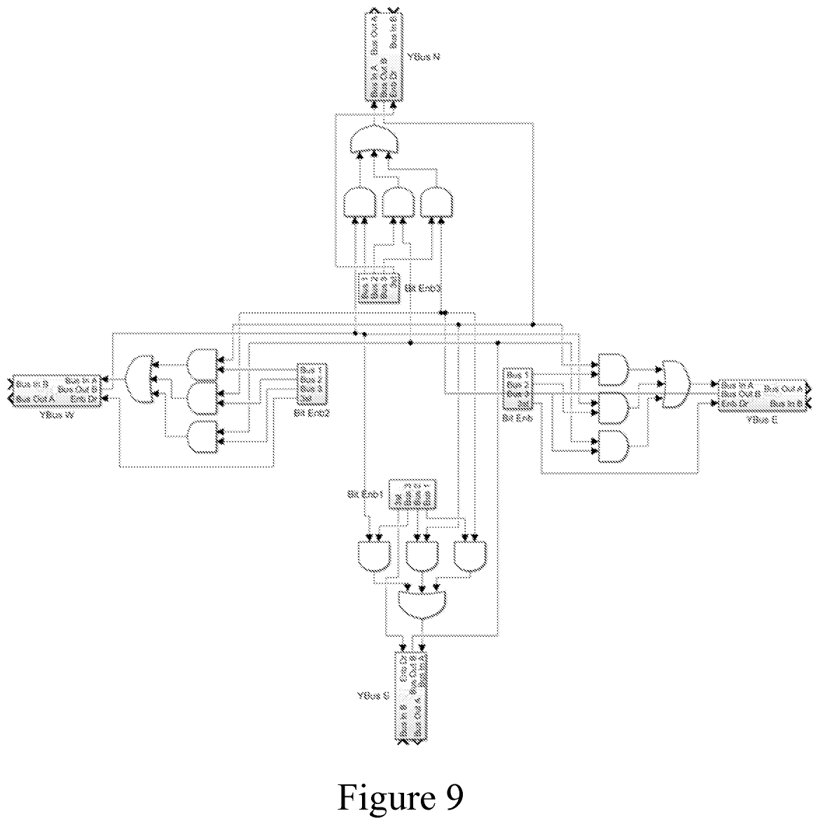

If the integrated circuit technology desired has no tristate option, FIG. 9 shows how the bus switch is adapted. In this situation, there must be 2 sets of bus lines in each of the 4 directions-one going into the switch, and one going out of the switch. The input lines are routed across the switch to the other output lines, enabled by the previously described gates, with the same control line logic. This structure effectively doubles throughput of the bus and makes the setup much simpler, at the expense of twice the chip area required for the bus signals. However, consideration must be given to the direction of data flow, which must be consistent across the entire set of clients.

### Local Bus Isolation

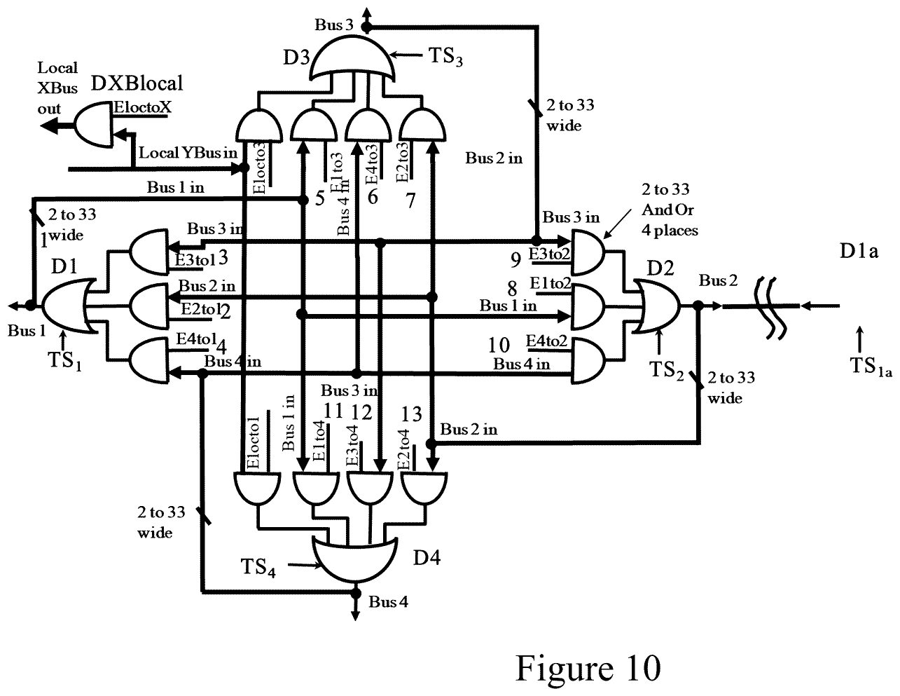

The local bus bottleneck tradeoff may be alleviated somewhat by isolating the local XBus and YBus from the bus switch (FIG. 10). This has the effect of opening the 4 buses to medium and long hall traffic without having to carry the possibly higher bandwidth local traffic, at the expense of minor additional circuitry. The circuitry here operates in the same manner as FIG. 9, with the added control lines to route the local YBus traffic to the long haul YBus (D3 or D4) as needed. Since the local XBus is only driven in this instance by the local YBus, the driver DXBlocal does not need to be a tristate driver. An additional And-Or gate can be used instead to allow long haul bus traffic into the XBus if inputs don't come from the local YBus.

### Multi-Path Transfers

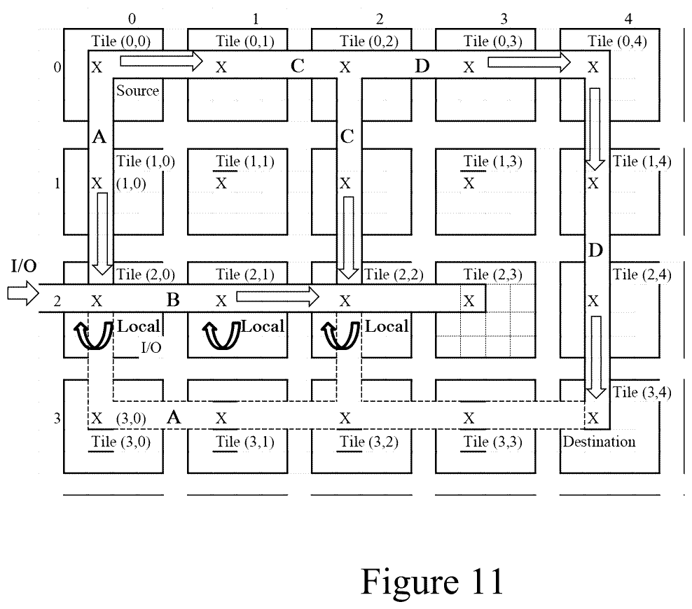

In order to increase total available bus bandwidth, the switch structure allows bypassing of local bottlenecks by broadcasting to use more than one path between source and destination. FIG. 11 shows an example. In this diagram the RAPC tiles (groups of RAPCs) that use cach switch are represented by simple squares. The switches, denoted as X, are referred to with the Tile designation in (X,Y) matrix row, column format.

Suppose the RAPC tile at (0,0) must send data to RAPC tile (3,4). Switch (0,0) is programmed for a multi-path transfer; it sends data on 2 paths: path A (from (0,0) to (3,0), which then turns a corner at (3,0), then goes to (3,4); and path C which goes from (0,0) to (0,2) to (3,2), then to (3,4).

The RAPC switch at (0,2) is also programmed to broadcast data on 2 paths—continue on path C, which rejoins path A on the bottom row, and also to send on path D which goes to RAPC switch (0,4) where the switch is programmed to provide a corner path to get the data to the destination at RAPC (3,4).

Suppose that on the clock cycle that path A data travels toward RAPC (3,0), higher priority local traffic (say, an I/O signal that must be processed) hogs the bus at RAPC (2,0) thru RAPC (2,3). Path A is momentarily blocked, so Uhalt\ is sent from (2,0) back to (0,0). That same traffic also blocks path C at (2,2). So Uhalt\ is also sent back from RAPC (2,2).

However, path D is not blocked. The destination RAPC, (3,4) deasserts Uhalt\, forcing it high. This signal propagates back path D to the RAPC source at (0,0). Because of the switch structure, the high signal from path D overrides the signals from paths stalled A and stalled C, so the source at (0,0) is informed that the data was received. It does not matter which switches the Uhalt\ signal is sent through; it arrives at tile (0,0). The or gate in the return signal path ensures that any Uhalt\ that is deasserted when the destination data is received will drive Uhalt\ high at the source, indicating the data was received.

Now assume the paths A, C and D all succeed in delivering the data to the destination. The switch will wire-or all the data when it is delivered. However, since the data is identical on all 3 paths and arrives within the same clock cycle, the wire-or of the data with itself has no effect on the result. The destination sees valid data. All that is required is for the data to be valid for the next clock cycle (Note that the wire-or function requires that data which is not valid must be 0.).

Since the transfer clock must run somewhat slower than the buses are capable of running because the worst case calculation in the RAPCs must be accounted for, the data will be valid at the destination-as long as the propagation delays through the switches. and back through the Uhalt\ feedback line is less than the time between clocks.

By ensuring that a full clock cycle elapses between the Source starting the transaction, the Destination receiving the transaction, and the Uhalt\ signal being sent back to the source, the length of the bus is maximized. If the fabric is small, this restriction can be relaxed. If the fabric is large, transfers can happen at a slower rate by using alternate clock cycles for Xclk.

### Y to X and X to Y

The 4 way switch is symmetrical, allowing not only Y to X transfers as was originally needed, but also X to Y transfers. This ability allows a much more flexible path for the data to follow to get anywhere in the fabric. FIG. 11 takes advantage of this capability in this example by allowing the bus transfer across several XBus switches without first going through a YBus, greatly reducing the number of gates required for the transfer per Xclock cycle—which in turn effectively increases the reach and transfer rate of the bus.

### Hierarchy and Priority Structure

The paths the data takes across the device must be consistent. Since data in our example is routed variously on several paths, with some straight through switches, some corner switches, and some broadcast switches, the switches on most data paths require different setups. Since several switches come into play during transmission, each switch setting will differ from the next. In fact, each switch can have 62 different but valid switch settings.

To make the switch control more tractable without losing generality of the transfer types, ideally one identical number would cause all the switches in each path to assume their proper configuration for that path. This is called here indirection.

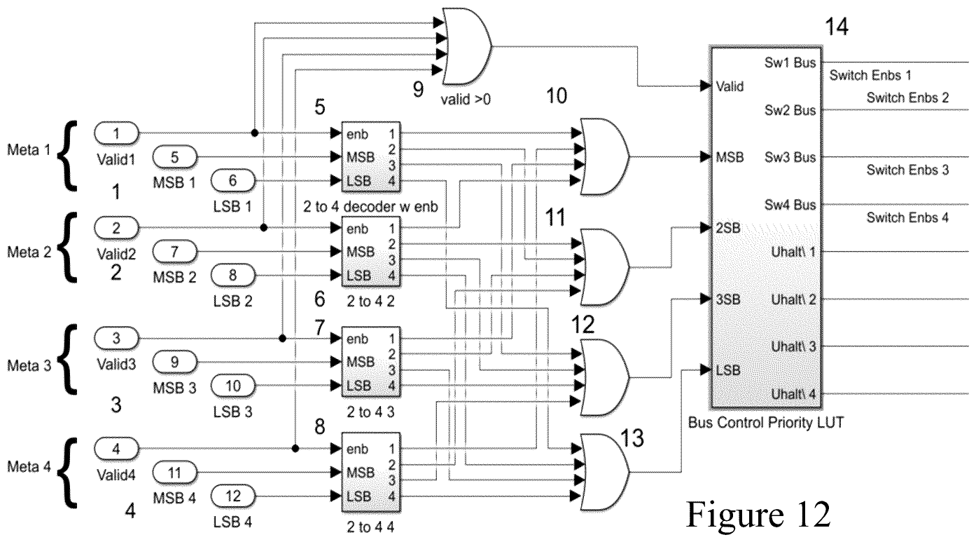

To arrange for indirection FIG. 12 shows an example embodiment of a 4 layer priority system that allows 4 different setups to be used in a given switch. The user loads the lookup table (LUT) 14 with each switch configuration he needs the clients to use, indexed by a priority number. The priority number common to all switches in a given data path accompanies the bus data as a switch meta tag. (serial buses will require additional decoding logic to pull the switch meta tag from the data stream if the switch meta tag is embedded within the data.) As the data travels down the path, the switch meta tag causes each successive switch in turn to reconfigure itself to pass the data on to the next switch (or switches). Each LUT can have completely different settings, allowing the data to go straight at one switch, turn a corner at another switch, and so on. While in transit, the same switch meta tag also configures the Uhalt\ feedback path accordingly. In this embodiment, a 2 line meta tag bus is used to direct the switch setup indirectly 1,2,3 and 4. The LUT finds the highest priority meta tag, which selects 1 of 4 possible switch setups to use for a given data transfer, and sends the upstream halt Uhalt\ to any of the other inputs whose lower priority inputs are not to be honored, shutting down their drivers but pausing their outputs. Standard gate configurations are shown for functional clarity and case of understanding. If gate delays through this logic become problematic, the priority selection portion of the design can be absorbed into the lookup table. Also, more than 4 configurations may be necessary for certain algorithms; the design can be easily expanded to more priority levels depending on the algorithms, the path needs and the number and complexity of the algorithms being executed by expanding the number of signals in the meta tag.

Each switch on a given path receives the same meta tag priority number from the source driver. The meta tag priority number selects the compatible switch configuration based on the source of the data, the travel direction and the transfer priority. The source priority accompanies the data along the bus as a switch meta tag, ensuring consistent switch configurations along the way. Priority determines which of the paths to choose, and which data must wait (by asserting Uhalt\ and sending it back to the source). Since the switch can handle data from more than one source and destination, more than one client can use the switch simultaneously because the data streams are kept separate.

Note that priority can differ at each switch.

Using this arrangement, multiple transfers through the same switch can be accomplished within a single transfer clock cycle, as long as bus logic and signal timing are met and both source and destination differ for each transfer requested. The user should ensure that all of the switch arrangements for a transfer have identical priorities for the multi-user situation for best throughput.

In this example, the switch meta tag was used to determine the transfer. Separate address lines as shown in FIG. 6 may also be used to drive the switch settings.

### Dataflow Architectures

Various features have been addressed using dataflow architectures. Data is transferred between bus clients, the data transfer buses being configurable to change the transfer path at each transfer cycle to optimize the data transfer throughput between the clients. This approach is used by hardwired specialty computational engines (such as gate arrays, including field programmable gate arrays or FPGAs). In this regard, an FGPA that is specifically programmed to perform and implement the invention herein.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

What is claimed is:

1. A computing system comprising:
a plurality of data bus clients;
a two-dimensional plurality of data transfer buses that transfer data between bus clients, the data transfer buses being configurable to change the transfer path at each transfer cycle to optimize the data transfer throughput between the clients.

2. The computing system of claim 1 where the data transfer bus is configurable to be logically separated into a plurality of independent bus sections at the request of the clients on the bus, during each data transfer cycle.

3. The computing system of claim 1 where the data transfer buses are configurable to transfer between compatible multiple paths simultaneously.

4. The computing system of claim 1 where the data transfer buses contain a priority resolution arrangement configurable to resolve incompatible client requests.

5. The computing system of claim 4 wherein the priority resolution arrangement is configurable to create a single common prioritized number that causes multiple different bus path configurations to create a specific bus path.

6. The computing system of claim 1 wherein the data bus can driven by tristatable drivers.

7. The computing system of claim 1 wherein the data bus is driven by non-tristatable drivers.

8. The computing system of claim 1 wherein the data bus is driven by wire-ored drivers.

9. The computing system of claim 1 wherein the data bus is a serial bus.

10. A computing system comprising:
a plurality of data bus clients arranged regularly in two dimensions;
a bus that is configurable to send data from at least one source client along multiple paths to a common destination, wherein any and all paths that get the data from the at least one source to the common destination client produce a successful transfer, and wherein any transfer informs a data source of the transfer status.

11. The computing system of claim 10 where a failure of all paths to transfer to the destination is configurable to cause the source to wait until at least one path becomes available to transfer the data.

12. A two-dimensional computing system with a layout of data clients on a common substrate, the two-dimensional computing system comprising:
a four way digitally controlled switch connecting the data bus clients, wherein the two-dimensional computing system is configurable to:
connect any two different bus client data sources with any two different client data sinks,
connect any single client data source with any of the other 3 client data sinks, and
connect any client data source to any client data sink through multiple data paths.

13. The computing system of claim 12 where a single common number from a client data source is configurable to cause successive digitally controlled switches to be differently configured in priority and in switch connections such that multiple paths are usable to get data to a destination client.
